(19) United States
(12) Patent Application Publication
(10) Pub. No.: US 2012/0314184 A1
(43) Pub. Date: Dec. 13, 2012

(54) 3D Contact Lenses

(76) Inventors: Enrique A. Saldivar, Temecula, CA (US); Jinky Irene B. Saldivar, Temecula, CA (US)

(21) Appl. No.: 13/158,823

(22) Filed: Jun. 13, 2011

(51) Int. Cl. G02C 7/04

(52) U.S. Cl. 351/159.27

(57) ABSTRACT

A three-dimensional contact lens for viewing three-dimensional imagery comprising: a central portion, wherein said central portion includes polarizing filters for viewing three-dimensional imagery; and an outer surrounding surface surrounding the central portion to make up the composite body of the contact lens.

### BACKGROUND OF THE INVENTION

1. Field of Invention

The present invention relates to three-dimensional contact lenses for use in watching three-dimensional imagery.

2. Description of Related Art

Contact lenses are lenses that are placed upon the cornea of the eyeball. Contact lenses are typically used for corrective, cosmetic or therapeutic purposes. Most contacts used today are soft contacts however rigid contacts are also available for use. Contacts lenses are used by millions of people principally for corrective purposes although some cosmetic purposes are available such as the ability to change the appearance of the eye of the wearer. Cosmetic contacts are known as decorative contacts and normally are used by the wearer to create a different color or size of the user's cornea. Contacts are also used for therapeutic purposes to correct non-refractive disorders of the eye.

Three-dimensional imagery have been developed over many years' to provide a viewer with a three-dimensional image of a motion picture or other visual presentation. Typically viewers of three-dimensional images wear special glasses to effectively view the three-dimensional imagery. Use of the 3D glasses while viewing the movie enables the user to enjoy a three-dimensional experience while viewing the movie picture. Further the latest technology includes three-dimensional Blu-ray players where users wear special headgear or three-dimensional glasses while viewing the motion picture being shown on the three-dimensional Blu-ray player. Consequently in either application a viewer must wear some type of headgear or glasses in order to fully appreciate the aspects of three-dimensional imagery. Consequently, it would be advantageous if a user were able to insert contact lenses that provide suitable refraction for the user to enjoy a three-dimensional image.

### SUMMARY OF THE INVENTION

The present invention relates to a three-dimensional contact lens for viewing three-dimensional imagery comprising: a central portion, wherein said central portion includes polarizing filters for viewing three-dimensional imagery; and an outer surrounding surface surrounding the central portion to make up the composite body of the contact lens.

### BRIEF DESCRIPTION OF DRAWINGS

FIG. 1 depicts a front view of a three-dimensional contact lens in accordance with the present invention.

FIG. 2 depicts a side view of the three-dimensional contact lens according to the present invention.

### DETAILED DESCRIPTION

The present invention relates to three-dimensional contact lenses that are used as an alterative method in watching three-dimensional imagery. Three-dimensional imagery is widely available when viewing motion pictures and recently in relation to three-dimensional Blu-ray players that may be used in a home environment. Further some television channels have implemented the use of three-dimensional imagery. The three-dimensional imagery in all these applications' require the use of some type of headgear or glasses for the wearer. The present invention contemplates use of a contact lens that is inserted onto the cornea of the user's eye while viewing a three-dimensional image.

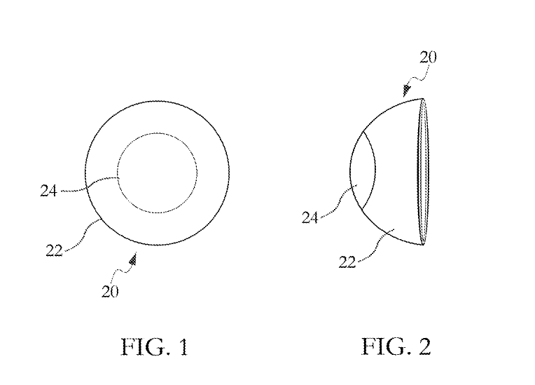

In reference to FIG. 1, a front view of a three-dimensional contact lens (20) is depicted. This three-dimensional contact lens (20) includes a center surface area (24) surrounded by an outer surface area (22). The center surface area (24) is positioned over the user's cornea and provides suitable technology for viewing three-dimensional imagery. The three-dimensional surface area (24) incorporates reflective polarizing filters that assist the user in viewing three-dimensional imagery so that the illusion of depth and close proximity may be enjoyed during the user's use of the contact lens (20). A side view of contact lens (20) is depicted in FIG. 2. As shown in FIG. 2 a clear depiction of the dimensioning of the contact lens (20) is shown. The center portion (24) is shown at the tip of the contact lens (20) with the surrounding surface area (22).

The contact lens (20) according to the present invention provides an alternative method to view three-dimensional imagery and alleviates the user of the necessity of having headgear or eyewear when viewing three-dimensional images. The contact lenses may be made of polymer materials and include the polarizing filters that are necessary to fully enjoy a three-dimensional motion picture or a video. The three-dimensional lenses may be of a typical soft contact lens material and distributed via the makers of 3D imagery.

What is claimed is:

1. A three-dimensional contact lens for viewing three-dimensional imagery comprising:
a central portion, wherein said central portion includes polarizing filters for viewing three-dimensional imagery; and
an outer surrounding surface surrounding the central portion to make up the composite body of the contact lens.
